(19) United States
(12) Patent Application Publication
(10) Pub. No.: US 2006/0057040 A1
(43) Pub. Date: Mar. 16, 2006

(54) Portable hydrogen supply system

(75) Inventors: Chih-Kang Shih, Taipei City (TW); George Huang, Taipei City (TW); Anne An, Taipei City (TW)

Correspondence Address: TROXELL LAW OFFICE PLLC;SUITE 1404, 5205 LEESBURG PIKE, FALLS CHURCH, VA, 22041, US

(73) Assignee: H Bank Technology Inc.

(21) Appl. No.: 11/008,125

(22) Filed: Dec. 10, 2004

(30) Foreign Application Priority Data
Sep. 15, 2004 (TW) 093127930

(51) Int. Cl. B01J 8/02

(52) U.S. Cl. 422/211; 422/190; 422/105

(57) ABSTRACT

The invention provides a portable hydrogen supply system for safely storing hydrogen and capable of supplying hydrogen in gaseous form to a hydrogen-using device. The hydrogen supply system includes at least one hydrogen storage canister and a control valve, and provides a port. When the hydrogen supply system, with hydrogen previously absorbed in each hydrogen storage canister, connects with the hydrogen-using device, the hydrogen supply system supplies hydrogen with a stable pressure at the port to the hydrogen-using device, and the pressure of the hydrogen supplied by said system is capable of being changed by adjusted the control valve.

### BACKGROUND OF THE INVENTION

1. Field of the Invention

The present invention relates to a portable hydrogen supply system for supplying hydrogen in gaseous form to a hydrogen-using device, for example, fuel cell, gas chromatography system, fluorescence spectrometer, etc.

2. Description of the Prior Art

Previous hydrogen supply systems mostly store hydrogen in gaseous form or liquid form. Because gaseous hydrogen and liquid hydrogen are inflammable, it's worrisome that previous hydrogen supply systems may induce explosions. To lower the danger of explosions, previous hydrogen supply systems are fixed for preventing them from toppling over. Therefore, previous hydrogen supply systems are not portable.

As the development of techniques for storing hydrogen in solid form, namely the development of hydrogen storage alloys, the safety of devices for storing hydrogen is substantially raised. However, most prior devices using hydrogen storage alloys use hydrogen indirectly. For example, instead of consuming hydrogen by burning, general devices using hydrogen storage alloys, such as nickel-metal hydride battery and fuel cell, directly convert chemical energy to electric energy in electrochemistry reactions. Take fuel cell as example, hydrogen storage canisters for storing hydrogen storage alloys are compulsory components in fuel cells. Besides, hydrogen storage alloys have the character of releasing/absorbing heat during the process of absorbing/releasing hydrogen through chemical reactions; so heat exchanging devices using hydrogen storage alloys are built. The same as fuel cells, hydrogen storage canisters for storing hydrogen storage alloys are also compulsory components in heat exchanging devices.

Accordingly, one objective of this invention is providing a hydrogen supply system for storing hydrogen safely and supplying hydrogen in gaseous form to a hydrogen-using device, for example, fuel cell, gas chromatography system, fluorescence spectrometer, etc. Especially, the hydrogen supply system according to this invention is designed to be portable. Thus, the safety of the above hydrogen-using devices and the safety of transporting hydrogen sources are conformed. It's also more convenient for the transporting of hydrogen sources. If the above hydrogen-using devices are portable and portable hydrogen supply systems are used, the practicability of using portable hydrogen-using devices in situ is raised.

### SUMMARY OF THE INVENTION

An objective of the present invention is to provide a portable hydrogen supply system for supplying hydrogen in gaseous form to a hydrogen-using device, for example, fuel cell, gas chromatography system, fluorescence spectrometer, etc.

A hydrogen supply system, according to one preferred embodiment of this invention, includes a housing, at least one hydrogen storage canister, a piping means, and a control valve. The housing has a first partition disposed therein and an inner wall. Each hydrogen storage canister accommodates a hydrogen storage alloy, is spaced from one another, is mounted onto the first partition of the housing, and has a respective opening exposed between the first partition and the inner wall of the housing. The piping means has a first end and a second end exposed outside the housing. The first end of the piping means is sealingly connected to the opening of each hydrogen storage canister. An inlet/outlet port is provided at the second end of the piping means. The control valve is arranged on the piping means near the inlet/outlet port thereof. When the system, with previously charged hydrogen in the at least one hydrogen storage canister, connects with the hydrogen-using device, the system supplies hydrogen with a stable pressure at the inlet/outlet port to the hydrogen-using device, and the pressure of the hydrogen supplied by the system is capable of being varied by adjusting the control valve.

The advantage and spirit of the invention may be understood by the following recitations together with the appended drawings.

### BRIEF DESCRIPTION OF THE APPENDED DRAWINGS

FIG. 1A shows the inner structure of the hydrogen supply system 1 according to one preferred embodiment of this invention.

FIG. 1B shows the appearance of the hydrogen supply system 1 according to one preferred embodiment of this invention.

FIG. 2 shows the fan module 2 for assisting the hydrogen supply system 1 in the circulation of inner atmosphere.

FIG. 3A shows another arrangement form of the hydrogen storage canisters 14 in FIG. 1A.

FIG. 3B shows the appearance of the hydrogen supply system 1 in FIG. 3A.

FIG. 4 shows the hydrogen supply system combination 2 built with the hydrogen supply system 1 as a unit therein.

FIG. 5 shows the hydrogen supply system 1 in FIG. 1A with another piping means and control valve.

### DETAILED DESCRIPTION OF THE INVENTION

The present invention provides a portable hydrogen supply system for supplying hydrogen in gaseous form to a hydrogen-using device. Several preferred embodiments of this invention described below can point out the spirits and characteristics of this invention.

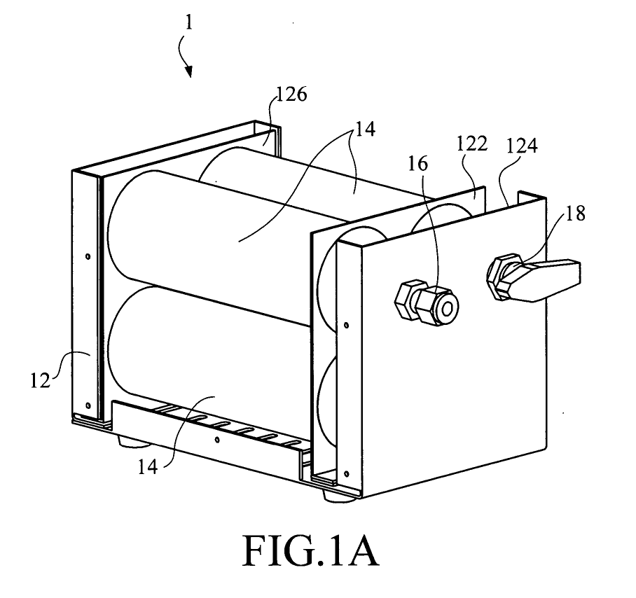

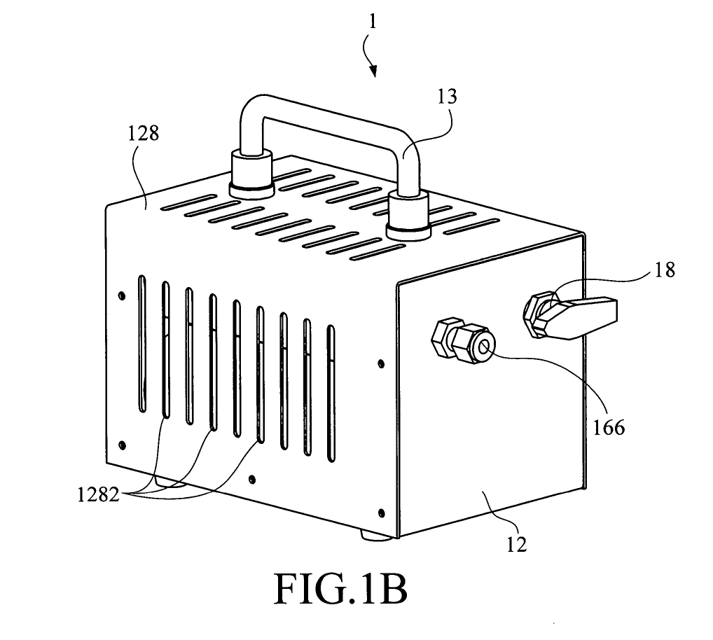

Referring to FIG. 1A and FIG. 1B, the hydrogen supply system 1 according to one preferred embodiment of this invention is shown. FIG. 1 A shows the inner structure of the hydrogen supply system 1. FIG. 1B shows the appearance of the hydrogen supply system 1.

As shown in FIG. 1A, the hydrogen supply system 1 includes a housing 12, at least one hydrogen storage canister 14, a piping means, and a control valve 18.

As shown in FIG. 1A, the housing 12 has a first partition 122 disposed therein and an inner wall 124.

Each hydrogen storage canister 14 accommodates a hydrogen storage alloy. As described above, hydrogen storage alloys have the character of releasing/absorbing heat during the process of absorbing/releasing hydrogen chemical reactions. Hence, when each of the hydrogen storage canisters 14 releases hydrogen, the surrounding temperature drops. Further more, the reaction speeds of releasing hydrogen for the surrounding hydrogen storage canisters 14 are influenced. To reduce the mutual influences between the hydrogen storage canisters 14 when absorbing/releasing hydrogen, each hydrogen storage canister 14 is spaced from one another and arranged properly. As shown in FIG. 1A, the four hydrogen storage canister 14 are arranged in a matrix form for better circulation of inner atmosphere when the hydrogen storage canisters 14 absorb/release hydrogen.

As shown in FIG. 1B, the housing 12 also has a case 128 providing several ventilators 1282 and a handle 13 thereon. The several ventilators 1282 are provided for enabling the inner atmosphere of the hydrogen supply system to flow out; thus, the mutual influences between the hydrogen storage canisters 14 when absorbing/releasing hydrogen are reduced. The handle 13 is designed for the convenience of carrying the hydrogen supply system.

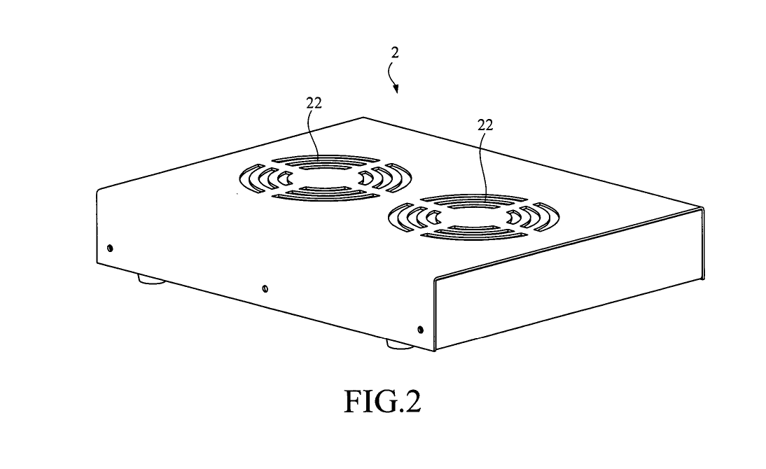

Also as shown in FIG. 1A, the hydrogen storage canisters 14 are mounted onto the first partition 122. The purpose of the first partition 122 is to prevent the hydrogen storage canisters 14 from directly touching the case 128 of the housing 12; thus, the case 128 of the housing 12 will not be heated or frosted when the hydrogen storage canisters 14 absorbs/releases hydrogen. The base of the housing 12 can also have ventilators. The hydrogen supply system 1 with a base having ventilators can build the fan module 2 as shown in FIG. 2. The fans in the fan module 2 send air into the hydrogen supply system 1 through blower holes 22 and the ventilating holes on the base of the hydrogen supply system 1; thus, the circulation of the inner atmosphere in the hydrogen supply system 1 is improved and the efficiencies of absorbing/releasing hydrogen for the hydrogen storage canisters 14 are further maintained.

As shown in FIG. 1A, each hydrogen storage canister 14 has a respective opening exposed between the first partition 122 and the inner wall 124.

To firm up the hydrogen storage canisters 14, as shown in FIG. 1A, the housing also has a second partition 126 and the hydrogen storage canisters 14 are mounted between the first partition 122 and the second partition 126. Except for firming up the hydrogen storage canisters 14, the second partition 126 is also for preventing the hydrogen storage canisters 14 from directly touching the case 128 of the housing 12; thus, the case 128 of the housing 12 will not be heated or frosted when the hydrogen storage canisters 14 when absorbs/releases hydrogen.

As shown in FIG. 1A, the piping means has a first end and a second end exposed. The first end of the piping means is sealingly connected to the opening of each hydrogen storage canister 14. An inlet/outlet port 16 is provided at the second end of the piping means.

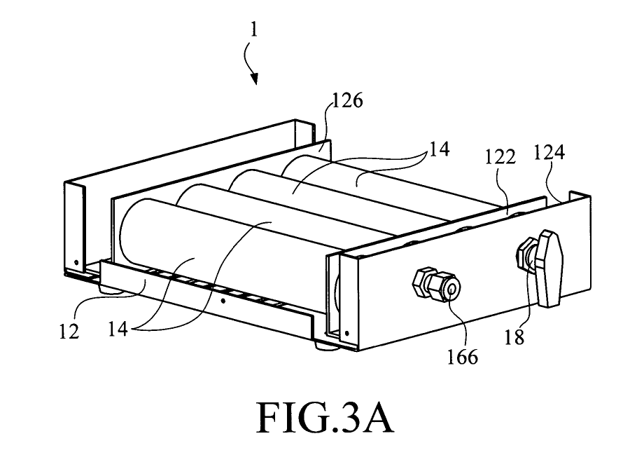

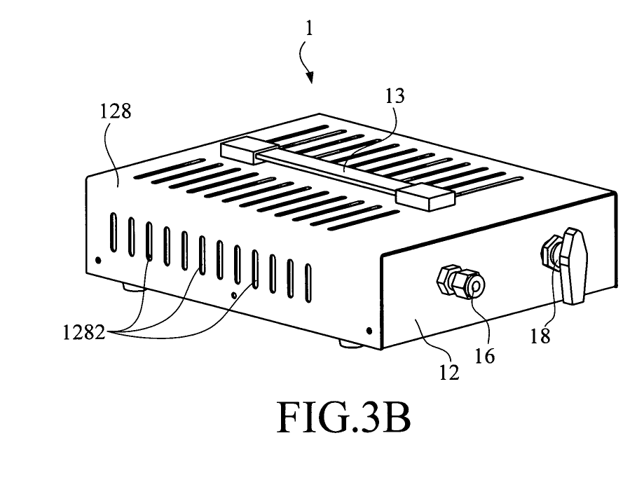

The variations of the hydrogen supply system 1 are shown in FIG. 3A and FIG. 3B. FIG. 3A shows a variation of inner structure of the hydrogen supply system 1. FIG. 3B shows the appearance of the hydrogen supply system 1 shown in FIG. 3A.

As shown in FIG. 3A, each hydrogen storage canister 14 is spaced from one another and arranged in a row for better circulation of inner atmosphere when the hydrogen storage canisters 14 absorb/release hydrogen. The components in FIG. 3B have the same numbers as those in FIG. 1B and have the same functions as the corresponding units in FIG. 2.

Hydrogen storage alloys all have a characteristic of showing plateau pressure on the PCI (Pressure-composition-isotherm) curve. Before using the hydrogen supply system 1, it can be connected with a hydrogen source which has a pressure higher than the plateau pressure of the hydrogen storage alloys stored in the hydrogen storage canisters 14; thus, hydrogen is filled into the hydrogen supply system 1 and is stored in the hydrogen storage canisters 14.

When the hydrogen supply system 1, with previously charged hydrogen in the at least one hydrogen storage canister, connects with the hydrogen-using device, the system supplies hydrogen with a stable pressure at the inlet/outlet port 16 to the hydrogen-using device because the hydrogen storage alloys have the characteristic of showing plateau when releasing hydrogen. The pressure of the hydrogen supplied by the hydrogen supply system 1 is capable of being varied by adjusting the control valve 18.

In one embodiment, the hydrogen storage alloys are AB₅ type alloys and represented by Lm(NiₓM_{y}), where Lm is a La-rich misch metal and comprises La and at least one element selected from the group consisting of Ce, Pr, Nd, and Sm. M comprises at least one element selected from the group consisting of Al, Ti, Zr, Sn, and Ca. x and y are molar numbers, wherein 4.0≦x≦5.0, 0≦y≦1.0, and x+y=5.

In another embodiment, when La occupies in an amount of 70 to 90 wt. % of Lm in the hydrogen storage alloy and Ce occupies in an amount of 5 to 25% wt. % of Lm in the hydrogen storage alloy, the pressure of the hydrogen supplied by said system is higher than 0.1 MPa at room temperature by fully-opening the control valve.

In another embodiment, when La occupies in an amount of 50 to 70 wt. % of Lm in the hydrogen storage alloy and Ce occupies in an amount of 25 to 45 wt. % of Lm in the hydrogen storage alloy, the pressure of the hydrogen supplied by said system is higher than 0.5 MPa at room temperature by fully-opening the control valve.

In practice applications, the hydrogen supply system 1 is previously connected with a hydrogen source to store hydrogen in an atomic form into the hydrogen storage alloys in each hydrogen storage canister 14. It should be noticed that the hydrogen pressure in the hydrogen source must be higher the pressure of the hydrogen then provided by the hydrogen supply system 1.

In one embodiment, the hydrogen-using device can be a fuel cell, a gas chromatography system, a fluorescence spectrometer, or other devices using hydrogen sources directly.

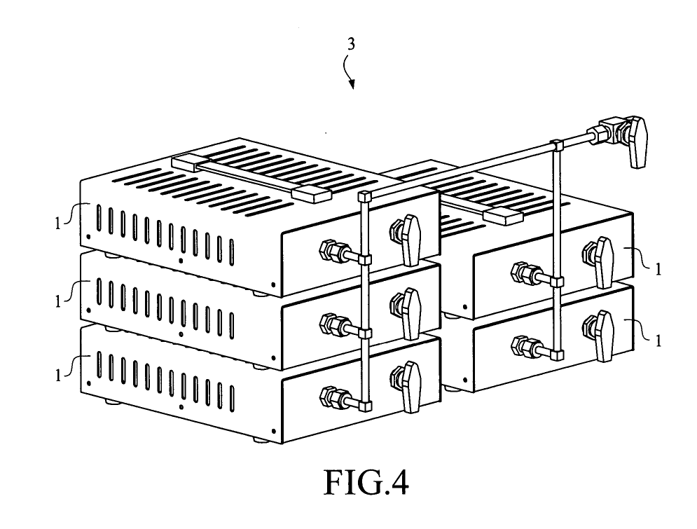

Except being used singly, the hydrogen supply system 1 according to this invention can also be used as a unit for combining several units to build a hydrogen supply system combination 3, as shown in FIG. 4.

A hydrogen supply system according to this invention can also be used as a hydrogen filter to purify the hydrogen in a hydrogen source. Take the hydrogen supply system 1 shown in FIG. 1A or FIG. 3A as an example, if the original purity of the hydrogen in a hydrogen source is 99.99%, after supplying hydrogen from the hydrogen source to the hydrogen supply system 1, the purity of the hydrogen supplied by the hydrogen supply system 1 can at least achieve 99.9995%.

Hydrogen with high purity is often used when manufacturing semiconductors. For example, hydrogen is used as the reaction gas with trichlorosilane to form epitaxial silicon. However, the vapor generated when burning hydrogen will react with oxygen and encourage the growth of thermal oxide. Accordingly, current industries have strict specifications for the purity of hydrogen. Some industrial requirements for the purity of hydrogen are listed in Table 1.

TABLE 1

| Level | Extra-high | Electrical | VLSI |
|---|---|---|---|
| Minimum Purity | 99.999% | 99.9995% | 99.9999% |
| SEMI Specification | — | — | SEMI C3.19-93 |

Most hydrogen with high purity is transported under high pressure and low temperature conditions currently. However, impurities may permeate into the hydrogen with high purity during the process of transferring and transporting and the purity will be lowered. Manufacturers have to use expensive and complicated hydrogen filters to filter the transported hydrogen for achieving the requirements.

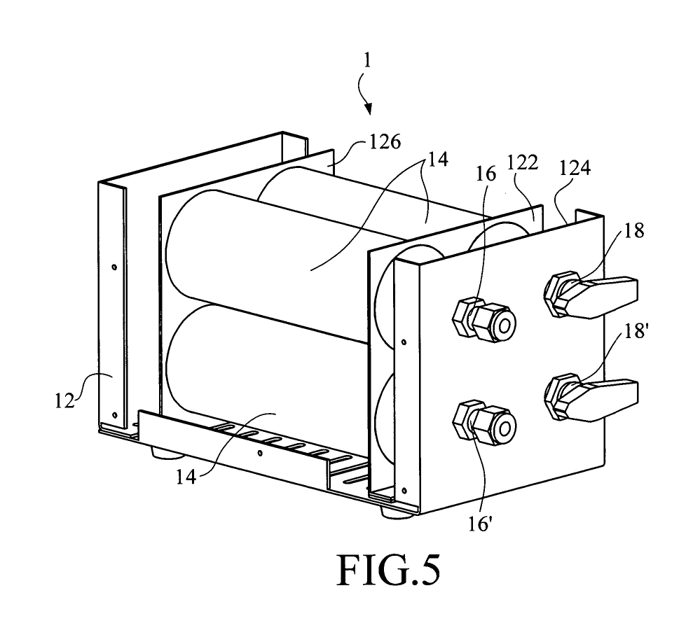

A hydrogen supply system according to this invention can also be used as a cheap and simple hydrogen filter. As described above, the hydrogen supply system with a single inlet/outlet port can filter hydrogen with 99.99% purity to hydrogen with 99.9995%. As shown in FIG. 5, another piping means and a control valve 18′ are added to the hydrogen supply system 1 disclosed in FIG. 1A to provide two inlet/outlet ports (16 and 16′) for the hydrogen supply system 1. The other piping means and the control valve 18′ are arranged the same as the original piping means and the control valve 18. The housing 12 and each hydrogen storage canister 14 cooperate with the other piping means and the control valve 18′ in the same way as cooperating with the original piping means and the control valve 18. When the hydrogen supply system 1 as shown in FIG. 5 with a hydrogen source, the hydrogen in the hydrogen source can be inputted via an inlet/outlet port (for example, port 16) of the hydrogen supply system 1 and outputted via the other inlet/outlet port (for example, port 16′) of the hydrogen supply system 1. If the original purity of hydrogen in the hydrogen source is 99.99% and the hydrogen in the hydrogen source is cyclically filtered by the hydrogen supply system 1 shown in FIG. 5, the purity can achieve at least 99.9999%, as the specification in VLSI manufactures.

The characteristics and advantages of this invention are summarized and listed below:
(a) The hydrogen supply system according to this invention stores hydrogen safely and supplies hydrogen in gaseous form to a hydrogen-using device. Hence, the safety of hydrogen-using devices and the safety of transporting hydrogen sources are conformed.
(b) The hydrogen supply system according to this invention is a portable hydrogen supply system. In this way, the convenience of transporting of hydrogen sources is raised. By combining portable hydrogen-using devices and portable hydrogen supply system, the practicability of using portable hydrogen-using devices in situ is elevated.
(c) The hydrogen supply system according to this invention is a portable hydrogen supply system. Accordingly, hydrogen supply systems in fuel cells can be changed to unfixed and portable systems.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A hydrogen supply system for safely storing hydrogen and capable of supplying hydrogen in gaseous form to a hydrogen-using device, said system comprising:
a housing having a first partition disposed therein and an inner wall;
at least one hydrogen storage canister which each accommodates a hydrogen storage alloy, is spaced from one another, is mounted onto the first partition of the housing, and has a respective opening exposed between the first partition and the inner wall of the housing;
a piping means having a first end and a second end exposed outside the housing, the first end of the piping means being sealingly connected to the opening of each hydrogen storage canister, an inlet/outlet port being provided at the second end of the piping means; and
a control valve arranged on the piping means near the inlet/outlet port thereof;
wherein when said system, with previously charged hydrogen in the at least one hydrogen storage canister, connects with the hydrogen-using device, said system supplies hydrogen with a stable pressure at the inlet/outlet port to the hydrogen-using device, and the pressure of the hydrogen supplied by said system is capable of being varied by adjusting the control valve.

2. The hydrogen supply system of claim 1, wherein the hydrogen storage alloy is a AB₅ type alloy and represented by Lm(NiₓM_{y}), where Lm is a La-rich misch metal and comprises La and at least one element selected from the group consisting of Ce, Pr, Nd, and Sm, M comprises at least one element selected from the group consisting of Al, Ti, Zr, Sn, and Ca, x and y are molar numbers, 4.0≦x≦5.0, 0≦y≦1.0, and x+y=5.

3. The hydrogen supply system of claim 2, wherein when La occupies in an amount of 70 to 90 wt. % of Lm in the hydrogen storage alloy and Ce occupies in an amount of 5 to 25% wt. % of Lm in the hydrogen storage alloy, the pressure of the hydrogen supplied by said system is higher than 0.1 MPa at room temperature by fully-opening the control valve.

4. The hydrogen supply system of claim 2, wherein when La occupies in an amount of 50 to 70 wt. % of Lm in the hydrogen storage alloy and Ce occupies in an amount of 25 to 45 wt. % of Lm in the hydrogen storage alloy, the pressure of the hydrogen supplied by said system is higher than 0.5 MPa at room temperature by fully-opening the control valve.

5. The hydrogen supply system of claim 1, wherein the hydrogen-using device is one selected from the group consisting of a fuel cell, a gas chromatography system and a fluorescence spectrometer.

6. The hydrogen supply system of claim 1, wherein the housing also has a second partition disposed therein, the at least one hydrogen storage canister is mounted between the first partition and the second partition.

7. The hydrogen supply system of claim 1, wherein the housing also has a cover providing a plurality of ventilators thereon and a handle.

8. A hydrogen supply system capable of connecting with a hydrogen source, comprising:
a housing having a first partition disposed therein and a first inner wall;
at least one hydrogen storage canister which each accommodates a hydrogen storage alloy, is spaced from one another, is mounted onto the first partition of the housing, and has a respective first opening exposed between the first partition and the first inner wall of the housing;
first piping means having a first end and a second end exposed outside the housing, the first end of the first piping means being sealingly connected to the first opening of each hydrogen storage canister, a first inlet/outlet port being provided at the second end of the first piping means; and
a first control valve arranged on the first piping means near the first inlet/outlet port thereof;
wherein when said system connects with the hydrogen source, said system storages hydrogen exhausted by the hydrogen source, and exhausts hydrogen in gaseous form to the hydrogen source, and the pressure of the hydrogen exhausted by said system is capable of being varied by adjusting the first control valve.

9. The hydrogen supply system of claim 8, wherein the hydrogen storage alloy is a AB₅ type alloy and represented by Lm(NiₓM_{y}), where Lm is a La-rich misch metal and comprises La and at least one element selected from the group consisting of Ce, Pr, Nd, and Sm, M comprises at least one element selected from the group consisting of Al, Ti, Zr, Sn, and Ca, x and y are molar numbers, 4.0≦x≦5.0, 0≦y≦1.0, and x+y=5.

10. The hydrogen supply system of claim 9, wherein when La occupies in an amount of 70 to 90 wt. % of Lm in the hydrogen storage alloy and Ce occupies in an amount of 5 to 25% wt. % of Lm in the hydrogen storage alloy, the pressure of the hydrogen supplied by said system is higher than 0.1 MPa at room temperature by fully-opening the first control valve.

11. The hydrogen supply system of claim 9, wherein when La occupies in an amount of 50 to 70 wt. % of Lm in the hydrogen storage alloy and Ce occupies in an amount of 25 to 45 wt. % of Lm in the hydrogen storage alloy, the pressure of the hydrogen supplied by said system is higher than 0.5 MPa at room temperature by fully-opening the first control valve.

12. The hydrogen supply system of claim 8, wherein the housing also has a second partition disposed therein and a second inner wall, the at least one hydrogen storage canister is mounted between the first partition and the second partition, each hydrogen storage canister has a respective second opening exposed between the second partition and the second inner wall or between the first partition and the first inner wall.

13. The hydrogen supply system of claim 12, further comprising:
second piping means having a first end and a second end exposed outside the housing, the first end of the second piping means being sealingly connected to the second opening of each hydrogen storage canister, a second inlet/outlet port being provided at the second end of the second piping means; and
a second control valve arranged on the second piping means near the second inlet/outlet port thereof;
wherein when said system connects with the hydrogen source, the hydrogen in the hydrogen source is exhausted through the first inlet/outlet port into said system, and is returned from said system through the second inlet/outlet port into the hydrogen source, the pressure of the hydrogen exhausted into said system is capable of being varied by adjusting the first control valve, and the pressure of the hydrogen exhausted by said system is capable of being varied by adjusting the second control valve.
